(19) United States
(12) Patent Application Publication
(10) Pub. No.: US 2024/0360327 A1
(43) Pub. Date: Oct. 31, 2024

(54) COATING COMPOSITION, COATING FILM AND ARTICLE, OPTICAL DEVICE, AND LIGHTING DEVICE

(71) Applicant: Mitsubishi Electric Corporation, Tokyo (JP)

(72) Inventors: Natsumi KOYAMA, Chiyoda-ku, Tokyo (JP); Yasuhiro YOSHIDA, Chiyoda-ku, Tokyo (JP)

(73) Assignee: Mitsubishi Electric Corporation, Tokyo (JP)

(21) Appl. No.: 18/566,100

(22) PCT Filed: Jun. 7, 2021
(86) PCT No.: PCT/JP2021/021603

§ 371 Date: Dec. 1, 2023

(51) Int. Cl. C09D 7/61; C08K 3/22; C08K 3/36; C09D 1/00; C09D 7/20; C09D 7/65; F21V 3/00; G02B 1/10

(52) U.S. Cl. CPC C09D 7/61; C09D 1/00; C09D 7/20; C09D 7/65; F21V 3/00; G02B 1/10; C08K 2003/2231; C08K 3/36; C08K 2201/005

(57) ABSTRACT

Provided is a coating composition that can more readily eliminate clouding of a substrate caused by the fogging phenomenon and can maintain higher transparency of a coating film than some coating compositions. The coating composition includes: silica fine particles having an average particle size of 3 nm or larger and 25 nm or smaller; metal oxide fine particles; a solvent having a boiling point of 150 degrees C. or higher and 300 degrees C. or lower, and water. The amount of the silica fine particles is 0.1 mass % or more and 5 mass % or less. The amount of the solvent is 20 mass % or more and 70 mass % or less.

### TECHNICAL FIELD

The present disclosure relates to a coating composition containing silica fine particles, a coating film and an article, an optical device, and a lighting device.

### BACKGROUND ART

Organic substances, such as plasticizers and additives, contained in rubber products and plastics that are parts other than substrates, such as glass of vehicles and buildings and transparent plastic covers of headlights, volatilize, and the organic substances having volatilized attach to the surfaces of the substrates to cause clouding. This phenomenon is called fogging and known to reduce the transparency of the substrates. Various techniques for reducing or preventing fogging of substrates have been proposed. For example, one of techniques for decomposing and removing organic substances causing fogging is a method for forming, on the surface of glass, a metal oxide thin film having a film thickness of 10 to 200 nm and showing photocatalytic activity, as disclosed in Patent Literature 1.

### CITATION LIST

### Patent Literature

Patent Literature 1: Japanese Unexamined Patent Application Publication No. 9-235140

### SUMMARY OF INVENTION

### Technical Problem

However, the technique disclosed in Patent Literature 1 has an issue of requiring time to completely eliminate organic substances attached to the thin film because a photocatalyst decomposes the organic substances on the thin film when the photocatalyst is excited by exposure to light energy.

The present disclosure has been made in light of the above circumstance, and an object of the present disclosure is to provide a coating composition that can more readily eliminate clouding of a substrate caused by the fogging phenomenon and can maintain higher transparency of a coating film than some coating compositions, a coating film and an article, an optical device, and a lighting device.

### Solution to Problem

To solve the above-mentioned issue and achieve the object, a coating composition according to an embodiment of the present disclosure includes: silica fine particles having an average particle size of 3 nm or larger and 25 nm or smaller; metal oxide fine particles; a solvent having a boiling point of 150 degrees C. or higher and 300 degrees C. or lower; and water. The amount of the silica fine particles is 0.1 mass % or more and 5 mass % or less. The amount of the solvent is 20 mass % or more and 70 mass % or less.

### Advantageous Effects of Invention

An embodiment of present disclosure has advantageous effects in more readily eliminating clouding of a substrate caused by the fogging phenomenon and maintaining higher transparency of a coating film than some coating compositions.

### BRIEF DESCRIPTION OF DRAWINGS

FIG. 1 is a cross-sectional view schematically illustrating an example structure of a coating film composed of a coating composition according to Embodiment 1.

FIG. 2 describes the advantageous effect of the coating film composed of the coating composition according to Embodiment 1.

FIG. 3 is a cross-sectional view schematically illustrating an example method for producing the coating film composed of the coating composition according to Embodiment 1.

FIG. 4 is a cross-sectional view schematically illustrating an example step in the method for producing the coating film composed of the coating composition according to Embodiment 1.

FIG. 5 is a cross-sectional view schematically illustrating an example step in the method for producing the coating film composed of the coating composition according to Embodiment 1.

FIG. 6 is a cross-sectional view schematically illustrating an example step in the method for producing the coating film composed of the coating composition according to Embodiment 1.

FIG. 7 is a front view of an example optical device having the coating film according to Embodiment 2.

FIG. 8 is a cross-sectional view taken along line A-A in FIG. 7.

FIG. 9 is a front view of an example optical device having the coating film according to Embodiment 2.

FIG. 10 is a cross-sectional view taken along line B-B in FIG. 9.

FIG. 11 is a front view of an example optical device having the coating film according to Embodiment 2.

FIG. 12 is a cross-sectional view taken along line C-C in FIG. 11.

FIG. 13 is a front view of an example optical device having the coating film according to Embodiment 2.

FIG. 14 is a cross-sectional view taken along line D-D in FIG. 13.

FIG. 15 is a front view of an example lighting device having the coating film according to Embodiment 3.

FIG. 16 is a cross-sectional view taken along line E-E in FIG. 15.

FIG. 17 illustrates the summery of the evaluation results of Examples and Comparative Examples.

### DESCRIPTION OF EMBODIMENTS

A coating composition, a coating film, an article, an optical device, and a lighting device according to embodiments of the present disclosure will be described below with reference to the drawings.

### Embodiment 1

### Coating Composition

A coating composition according to Embodiment 1 includes silica fine particles, metal oxide fine particles, a high-boiling point solvent, and water. The coating composition according to Embodiment 1 may further include fluororesin particles and a non-volatile hydrophilic organic substance. The components contained in the coating composition will be described below.

### Silica Fine Particles

The silica fine particles contained in the coating composition according to Embodiment 1 serve as a component that is a base of a coating film. The silica fine particles and the metal oxide fine particles in the coating composition can form and maintain the hydrophilic surface with high transparency in the coating film composed of the coating composition. Since the coating film composed of the coating composition of Embodiment 1 is formed by aggregation of the silica fine particles and the metal oxide fine particles, the coating film is porous in nanometer scale. The hydrophilic surface of the coating film can improve the ability to prevent or reduce the attachment of hydrophobic dirt and can make attached water spread easily and flow down easily. Since attached water is easy to spread, the water enters the spaces between the film surface and the dirt so that the dirt is easy to flow down.

Since the coating film composed of the coating composition of Embodiment 1 containing the silica fine particles as a base is porous and low in density, the interaction between the surface of the coating film and the attached matter, such as dust, is so low that the dirt is less likely to attach. When an organic substance causing clouding due to the fogging phenomenon is attached to the coating film composed of the coating composition of Embodiment 1, the organic substance permeates the silica fine particles to readily eliminate clouding, and the coating film can maintain transparency. The “clouding due to the fogging phenomenon” as used herein means that the coating film appears white and cloudy because of light scattering on the roughness produced by organic substances, such as plasticizers and solvents, attached on the surface of the coating film. Since the metal oxide fine particles are contained in the coating composition, the uneven absorption of an organic substance 18 does not affect visibility, and the coating film maintains high transparency and uniformity.

Silica fine particles have a lower refractive index than other inorganic particles and have a refractive index close to the refractive indexes of glass and transparent resins, such as plastics commonly used as substrates. When the substrate and the coating film have similar refractive indexes, white appearance resulting from light reflection off the interface between the substrate and the coating film and the surfaces of the substrate and the coating film is prevented or reduced, and the color tone of the substrate is less likely to be impaired.

The average particle size of the silica fine particles is preferably 3 nm or larger and 25 nm or smaller, particularly preferably 4 nm or larger and 10 nm or smaller. The average particle size refers to the average particle size of primary particles as measured by a laser light scattering or dynamic light scattering particle size analyzer. The primary particles refer to the smallest unit of particles and the particles that cannot be divided further. An assembly of primary particles, which is an aggregate of primary particles, is called secondary particles. When the silica fine particles have an average particle size of less than 3 nm, the coating film is too dense, and the intermolecular force between the film surface and the dirt is too large to obtain desired soil resistance. When the silica fine particles have an average particle size of more than 25 nm, the surface roughness of the coating film is so large that the coating film easily appears whitish. The silica fine particles have an average particle size of 3 nm or larger and 25 nm or smaller, and the coating film contains the metal oxide fine particles. With this configuration, the coating film has an appropriate density, and an organic substance causing clouding due to the fogging phenomenon easily permeates the surface of the coating film, and the organic substance permeates the porous film composed of the silica fine particles. This can readily eliminate clouding to maintain high transparency. In addition, the contact area between the surface of the coating film and the dirt, such as dust, is small enough to obtain sufficient soil resistance. Soil resistance means the ability to prevent or reduce attachment of dirt or the ability to easily eliminate the attached dirt.

The amount of the silica fine particles in the coating composition is preferably 0.1 mass % or more and 5 mass % or less, preferably 0.5 mass % or more and 2 mass % or less. When the amount of the silica fine particles in the coating composition is less than 0.1 mass %, the formed coating film may be too thin to obtain desired soil resistance. When the amount of the silica fine particles in the coating composition is more than 5 mass %, the coating film may be too thick, and cracks and roughness may be generated, so that the coating film may easily appear whitish. For the above reasons, the amount of the silica fine particles in the coating composition is preferably 0.1 mass % or more and 5 mass % or less. In particular, when the amount of the silica fine particles in the coating composition is 0.5 mass % or more and 2 mass % or less, a uniform coating film with an appropriate thickness can be formed, and sufficient soil resistance can be obtained.

The silica fine particles having the above features can be prepared in accordance with a known method. For example, colloidal silica prepared from an aqueous solution of sodium silicate or prepared by a sol-gel method can be used as silica fine particles. The silica fine particles may be spherical, or may have irregular shapes, such as hollow shapes, scale-like shapes, and rod-like shapes. In the case of using silica fine particles having scale-like shapes, the obtained film strength tends to be high. Thus, the use of silica fine particles having scale-like shapes provide preferred results in applications that require wear resistance. A mixture of scale-like silica and spherical silica can provide the coating film with both transparency and strength. Silica fine particles connected like a string of beads may be used.

### Metal Oxide Fine Particles

The metal oxide fine particles contained in the coating composition of Embodiment 1 preferably have a high refractive index and show transparency when the metal oxide fine particles are formed as a coating film. The presence of the metal oxide fine particles with a high refractive index has an effect of making less noticeable unevenness generated by permeation of the organic substance, which causes clouding due to the fogging phenomenon, through the coating film and contributes to transparency and uniformity of the coating film. Since the coating film containing silica fine particles as a base is porous, the coating film has a refractive index corrected for air. The coating film containing metal oxide fine particles with a high refractive index has a higher refractive index than a silica fine particle layer composed only of silica fine particles. There is therefore a small difference between the refractive index of the film containing the metal oxide fine particles and the refractive index of the organic substance. This makes less noticeable unevenness generated by permeation of the organic substance through the coating film to provide the coating film with transparency and uniformity.

The metal oxide fine particles preferably have a refractive index of 1.6 or more. When the metal oxide has a refractive index of 1.6 or more, the unevenness generated by permeation of the organic substance through the coating film composed of the coating composition of Embodiment 1 is reduced.

Metal oxides having high photocatalytic activity may also be used. When the coating film contains metal oxide fine particles having photocatalytic activity, the organic substance permeating the coating film decomposes in an environment exposed to sunlight or artificial light. Since such a meal oxide is hydrophilic, the metal oxide has the ability to wash away dirt on its surface, that is, self-cleaning properties.

The metal oxide may be an oxide of a single metal, a solid solution of two or more oxides, or a composite oxide. Examples of single metal oxides include aluminum oxide, titanium oxide, zirconium oxide, indium oxide, zinc oxide, tin oxide, lanthanum oxide, yttrium oxide, cerium oxide, and magnesium oxide. Examples of solid solutions of two or more oxides include indium tin oxide. Examples of composite oxides include barium titanate, perovskite, and spinel. When the coating film composed of the coating composition of Embodiment 1 containing a metal oxide having photocatalytic activity is applied onto the surface of a substrate made of a resin, for example, apatite-coated titanium oxide does not decompose the resin.

The average particle size of the metal oxide fine particles is preferably 1 nm or larger and 25 nm or smaller, particularly preferably 2 nm or larger and 10 nm or smaller. The average particle size refers to the average particle size of primary particles as measured by a laser light scattering or dynamic light scattering particle size analyzer. When the particle size is larger than 25 nm, lighter scattering may occur on the surface of the coating film to increase the haze. When the average particle size of the metal oxide fine particles is 1 nm or smaller, the coating film may be too dense, and the organic substance causing clouding due to the fogging phenomenon may be unlikely to permeate the coating film. In particular, when the average particle size of the metal oxide fine particles is 2 nm or larger and 10 nm or smaller, the coating film has appropriate density, and the organic substance causing clouding due to the fogging phenomenon more easily permeates the coating film.

The amount of the metal oxide fine particles relative to the silica fine particles in the coating composition is preferably 80 mass % or less and 2 mass % or more, particularly preferably 50 mass % or less and 5 mass % or more. When the amount of the metal oxide fine particles relative to the silica fine particles is 80 mass % or less and 2 mass % or more, the refractive index can be appropriately adjusted, and the effect of reducing unevenness generated by permeation of the organic substance, which causes clouding due to the fogging phenomenon, through the coating film tends to be obtained.

Examples of the shape of the metal oxide fine particles include spherical, granular, hollow, ellipsoidal, cubic, cuboidal, needle-like, columnar, rod-like, cylindrical, and scale-like shapes. To form a porous coating film, the shape is preferably a spherical, ellipsoidal, or columnar shape.

### High-Boiling Point Solvent

The high-boiling point solvent contained in the coating composition according to Embodiment 1 is a solvent having a boiling point higher than an ordinary temperature, more specifically, a solvent having a boiling point of 150 degrees C. or higher and 300 degrees C. or lower as described below. The drying rate of the coating composition in the process for forming the coating film can be controlled by use of a high-boiling point solvent. Thus, a liquid film can be formed while the initial concentration of the silica fine particles in the coating composition is maintained, and aggregation of the silica fine particles can be prevented during coating. In addition, the liquid film after coating can be leveled by changing the amount of the high-boiling point solvent such that the drying time is made long. These advantageous effects can provide a uniform coating film.

The high-boiling point solvent preferably has a boiling point of 150 degrees C. or higher and 300 degrees C. or lower. When the high-boiling point solvent has a boiling point of lower than 150 degrees C., the drying rate is too high to obtain the effect of preventing aggregation of the silica fine particles and the effect of leveling the liquid film after coating. When the high-boiling point solvent has a boiling point of higher than 300 degrees C., the solvent tends to remain in the coating film, and the coating film having desired properties is not obtained. For the above reasons, the high-boiling point solvent preferably has a boiling point of 150 degrees C. or higher and 300 degrees C. or lower.

The solubility of the high-boiling point solvent in water is preferably, but not necessarily, 70 mass % or more. This is because, when the solubility of the high-boiling point solvent in water is less than 70 mass %, the high-boiling point solvent easily separates from water.

Examples of the high-boiling point solvent include ethylene glycol, propylene glycol, propylene glycol propylene glycol monomethyl ether, ethylene glycol monomethyl ether, ethylene glycol monomethyl ether acetate, ethyl lactate, diethylene glycol dimethyl ether, dipropylene glycol dimethyl ether, dipropylene glycol dimethyl ether, diethylene glycol ethyl methyl ether, diethylene glycol isopropyl methyl ether, dipropylene glycol monomethyl ether, diethylene glycol diethyl ether, diethylene glycol monomethyl ether, diethylene glycol butyl methyl ether, tripropylene glycol dimethyl ether, triethylene glycol dimethyl ether, diethylene glycol monobutyl ether, ethylene glycol monophenyl ether, triethylene glycol monomethyl ether, diethylene glycol dibutyl ether, triethylene glycol butyl methyl ether, polyethylene glycol dimethyl ether, tetraethylene glycol dimethyl ether, polyethylene glycol monomethyl ether, and N-methyl-2-pyrrolidone. These high-boiling point solvents may be used alone or in combination of two or more.

The amount of the high-boiling point solvent in the coating composition is 20 mass % or more and 70 mass % or less, preferably 30 mass % or more and 50 mass % or less. When the amount of the high-boiling point solvent is less than 20 mass %, the effect of preventing aggregation of the silica fine particles and the effect of leveling the liquid film after coating are not sufficient. When the amount of the high-boiling point solvent is more than 70 mass %, the silica fine particles and optional fluororesin particles in the coating composition have low solubility and easily aggregate with each other. For the above reasons, the amount of the high-boiling point solvent in the coating composition is preferably 20 mass % or more and 70 mass % or less. In particular, when the amount of the high-boiling point solvent in the coating composition is preferably 30 mass % or more and 50 mass % or less, the effect of leveling the liquid film can be obtained while the silica fine particles and the fluororesin particles can be maintained in a dispersed state in the liquid film composed of the coating composition. This enables formation of a uniform coating film with high transparency.

### Water

Examples of water contained in the coating composition according to Embodiment 1 include, but are not limited to, tap water, pure water, reverse osmosis water (RO water), and deionized water. RO water is water obtained by removing impurities from tap water by use of a reverse osmosis membrane. To improve the dispersion stability of the silica fine particles in the coating composition, ionic impurities such as calcium ions and magnesium ions in water are preferably as less as possible. Specifically, water preferably contains 200 ppm or less of divalent or higher-valent ionic impurities, more preferably contains 50 ppm or less of divalent or higher-valent ionic impurities. When water contains more than 200 ppm of divalent or higher-valent ionic impurities, the silica fine particles may aggregate with each other, so that the coating composition may have poor coatability due to low fluidity, and the coating film may have low transparency.

The amount of water in the coating composition is preferably, but not necessarily, 25 mass % or more and 80 mass % or less, more preferably 50 mass % or more and 70 mass % or less. When the amount of water is less than 25 mass %, the silica fine particles and optional fluororesin particles in the coating composition may have low solubility and may easily aggregate with each other. When the amount of water is less than 25 mass %, the coating film may be so thick that defects, such as cracks, may tend to occur. When the amount of water is more than 80 mass %, the solid content in the composition may be too low to efficiently form the coating film. For the above reasons, the amount of the water in the coating composition is preferably 25 mass % or more and 80 mass % or less. In particular, when the amount of water in the coating composition is 50 mass % or more and 70 mass % or less, the silica fine particles and the fluororesin particles can be maintained in a dispersed state in the liquid film composed of the coating composition. This enables formation of a uniform coating film with appropriate thickness and high transparency.

### Fluororesin Particles

The coating composition according to Embodiment 1 may contain fluororesin particles. The fluororesin particles in the coating composition can form a hydrophobic surface on part of the formed coating film. This configuration can improve the ability to prevent attachment of dirt. The fluororesin particles can provide the surface of the coating film with lubricity. This can improve the wear resistance of the coating film.

Examples of the fluororesin particles include, but are not limited to, particles made of polytetrafluoroethylene (PTFE), tetrafluoroethylene-hexafluoropropylene copolymer (FEP), tetrafluoroethylene-perfluoroalkyl vinyl ether copolymer (PFA), ethylene-tetrafluoroethylene copolymer (ETFE), ethylene-chlorotrifluoroethylene copolymer (ECTFE), polyvinylidene fluoride (PVDF), polychlorotrifluoroethylene (PCTFE), polyvinyl fluoride (PVF), fluoroethylene-vinyl ether copolymer, fluoroethylene-vinyl ester copolymer, copolymers and mixtures of such substances, mixtures of these fluororesins and other resins, and other materials.

The average particle size of the fluororesin particles is preferably 80 nm or larger and 550 nm or smaller, more preferably 100 nm or larger and 500 nm or smaller. When the average particle size of the fluororesin particles is smaller than 80 nm, a hydrophobic portion may not be adequately formed on the surface of the coating film. When the particle size of the fluororesin particles is larger than 550 nm, the coating film may have large surface roughness, and dirt may be easily caught by roughness, so that desired soil resistance may not be obtained. In addition, the surface roughness of the coating film may cause light scattering to make the coating film whitish. For the above reasons, the average particle size of the fluororesin particles is preferably 80 nm or larger and 550 nm or smaller. In particular, when the average particle size of the fluororesin particles is 100 nm or more and 500 nm or less, the coating film has a hydrophobic surface and appropriate roughness due to the fluororesin particles and thus has sufficient soil resistance.

The transparency of the coating film can be improved by minimizing, to the extent possible, the surface roughness of the coating film formed by use of rod-like or scale-like fluororesin particles. The smoothness and transparency of the obtained film can be improved by use of a dispersion of the fluororesin particles that contains a low-molecular-weight component, a solvent, or other component, has flexibility during coating, and solidifies when these components volatilize after coating.

The fluororesin particles can be prepared in accordance with a known method. A commercial dispersion of fluororesin particles in water can be used as a material of the coating composition.

The amount of the fluororesin particles relative to the amount of the silica fine particles in the coating composition is preferably 5 mass % or more and 50 mass % or less, particularly preferably 10 mass % or more and 30 mass % or less. When the amount of the fluororesin particles relative to the amount of the silica fine particles in the coating composition is less than 5 mass %, the proportion of the hydrophobic surface on the surface of the coating film may be too low to obtain desired soil resistance. When the amount of the fluororesin particles relative to the amount of the silica fine particles is more than 50 mass %, dust tends to attach to the coating film, which is not preferred. For the above reasons, the amount of the fluororesin particles relative to the amount of the silica fine particles in the coating composition is preferably 5 mass % or more and 50 mass % or less. In particular, when the amount of the fluororesin particles relative to the amount of the silica fine particles in the coating composition is 10 mass % or more and 30 mass % or less, the coating film has a hydrophilic surface and a hydrophobic surface at an appropriate ratio and thus has sufficient soil resistance.

### Non-Volatile Hydrophilic Organic Substance

The coating composition according to Embodiment 1 may also contain a non-volatile hydrophilic organic substance, which is an organic substance that is not volatile and has hydrophilicity. The non-volatile hydrophilic organic substance in the coating composition can fill voids in the formed coating film and can reduce scattering inside the coating film to improve the transparency of the coating film. The non-volatile hydrophilic organic substance can improve the coatability of the coating composition.

The non-volatile hydrophilic organic substance may be any one of various non-volatile organic substances having no deliquescence. Examples of the non-volatile hydrophilic organic substance include polyethylene glycol, polypropylene glycol, polytetramethylene glycol, dimethicone copolyol, and mixtures of such substances.

The non-volatile hydrophilic organic substance may be a surfactant. The surfactant is preferably, not necessarily, a non-ionic surfactant that is less likely to cause, for example, aggregation of the silica fine particles. It is noted that anionic surfactants and cationic surfactants can also be used as long as the addition amount, the pH of the solvent, and other parameters are carefully selected.

Examples of non-ionic surfactants include polyoxyethylene alkyl ethers, polyoxyethylene alkyl phenol ethers, polyoxyethylene alkyl esters, polyoxyethylene alkyl amines, polyoxyethylene alkyl amides, sorbitan alkyl esters, and polyoxyethylene sorbitan alkyl esters.

Examples of anionic surfactants include higher alcohol sulfates (Na salts or amine salts), alkyl allyl sulfonates (Na salts or amine salts), alkyl naphthalene sulfonates (Na salts or amine salts), alkyl naphthalene sulfonate condensate, alkyl phosphates, dialkyl sulfosuccinate, rosin soap, and fatty acid salts (Na salts or amine salts).

Examples of cationic surfactants include octadecylamine acetate, imidazoline derivative acetate, polyalkylene polyamine derivatives or salts of such derivatives, octadecyl trimethyl ammonium chlorides, triethyl aminoethyl alkylamide halides, alkylpyridinium sulfates, and alkyltrimethyl ammonium halides.

The non-volatile hydrophilic organic substance may, not necessarily, have an average molecular weight of 400 or more and 500,000 or less, and preferably has 700 or more and 100,000 or less. When the average molecular weight is less than 400, the addition of a large amount of the non-volatile hydrophilic organic substance may increase attachment of dust, which is not preferred. When the average molecular weight is more than 500,000, the fluidity of the coating liquid may be so low that uniform coating may be difficult. For the above reasons, the non-volatile hydrophilic organic substance preferably has an average molecular weight of 400 or more and 500,000 or less. In particular, when the non-volatile hydrophilic organic substance has an average molecular weight of 700 or more and 100,000 or less, the coating liquid has appropriate fluidity, and a highly transparent coating film with filled voids in the coating film can be obtained.

The amount of the non-volatile hydrophilic organic substance relative to the amount of the silica fine particles in the coating composition is preferably 10 mass % or more and 40 mass % or less, particularly preferably 10 mass % or more and 30 mass % or less. When the amount of the non-volatile hydrophilic organic substance relative to the amount of the silica fine particles in the coating composition is less than 10 mass %, the voids inside the formed coating film may not be adequately filled with the coating composition, or the spread of the coating composition may be degraded, and the coating film may have insufficient transparency. When the amount of the non-volatile hydrophilic organic substance relative to the amount of the silica fine particles is more than 40 mass %, the coating film may be too soft and may have low durability. For the above reasons, the amount of the non-volatile hydrophilic organic substance relative to the amount of the silica fine particles in the coating composition is preferably 10 mass % or more and 40 mass % or less. In particular, when the amount of the non-volatile hydrophilic organic substance in the coating composition is 10 mass % or more and 30 mass % or less, the voids of the coating film can be adequately filled with the coating composition, and the coating film with high transparency can be formed.

### Others

The coating composition according to Embodiment 1 can contain components known in the art to provide the coating composition with various properties unless the advantageous effects of the present disclosure are impaired. Examples of such components include a coupling agent and a silane compound. The amount of these components added is not limited unless the advantageous effects of the present disclosure are impaired, and can be appropriately adjusted according to the types of components used.

The coating composition according to Embodiment 1 containing the components as described above can be produced by any method and may be produced in accordance with a method known in the art. Specifically, the coating composition can be prepared by blending and mixing the components described above with stirring the components.

Next, the coating film formed by use of the coating composition described above will be described.

### Coating Film

The coating composition according to Embodiment 1 is applied onto the substrate and dried to form a coating film.

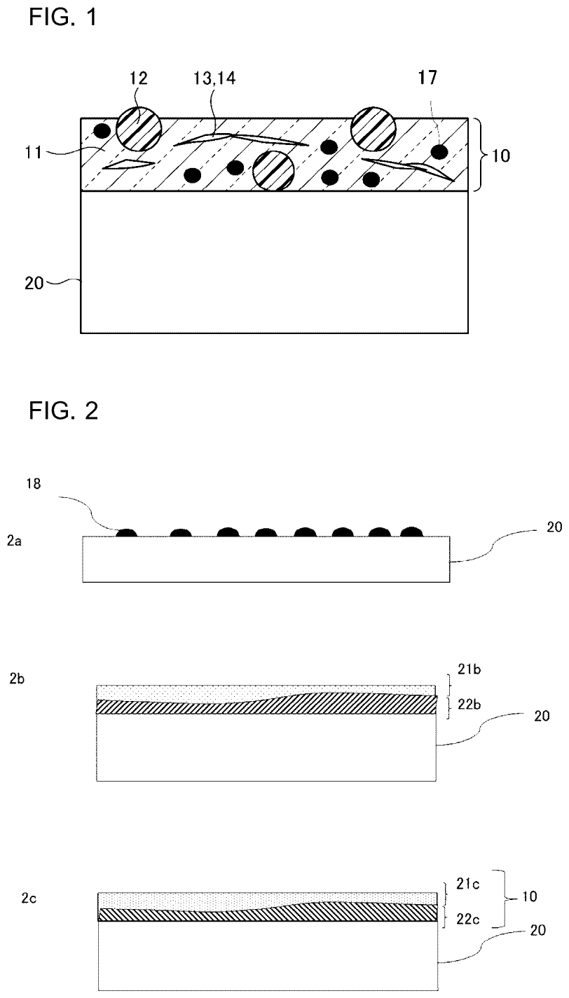

FIG. 1 is a cross-sectional view schematically illustrating an example structure of the coating film composed of the coating composition according to Embodiment 1. In this example, the coating composition contains silica fine particles, metal oxide fine particles, a high-boiling point solvent, water, fluororesin particles, and a non-volatile hydrophilic organic substance.

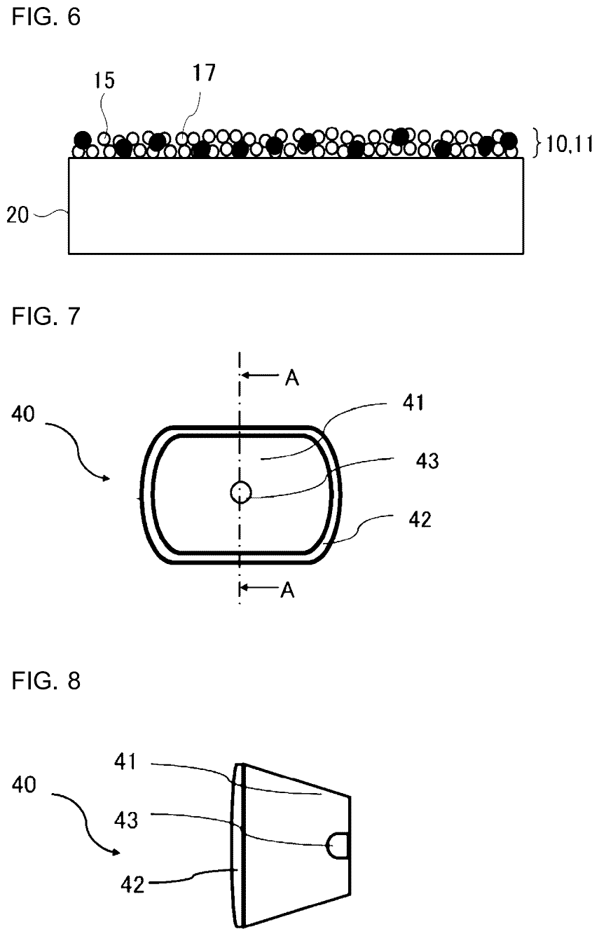

A coating film 10 includes a silica fine particle layer 11 disposed on a substrate 20 and formed by aggregation of silica fine particles 15 (shown in FIG. 6 or other figures described below) and metal oxide fine particles 17. Some of fluororesin particles 12 are exposed on the surface of the coating film 10, that is, the surface of the silica fine particle layer 11, and some are not exposed on the surface. In other words, the fluororesin particles 12 are partially exposed on the surface of the coating film 10 and dispersed in the silica fine particle layer 11.

FIG. 1 schematically illustrates cracks 13, which are example defects, formed by aggregation of the silica fine particles 15 when the liquid film of the applied coating composition is dried. In fact, small voids are formed instead of clear cracks 13 in many cases. In the related art, these defects scatter light to make the film whitish. In the coating film 10 composed of the coating composition according to Embodiment 1, however, the inside of these defects is filled with a non-volatile hydrophilic organic substance 14. This configuration prevents or reduces light scattering to increase the transparency of the coating film 10. The addition of the non-volatile hydrophilic organic substance 14 also provides the effect of preventing or reducing occurrence of these defects.

As illustrated in FIG. 1, the surface of the coating film 10 composed of the coating composition according to Embodiment 1 has both a hydrophilic portion attributed to the silica fine particles 15 and a hydrophobic portion attributed to the fluororesin particles 12.

Since the coating composition according to Embodiment 1 contains the high-boiling point solvent, the time until the coating film 10 is formed after coating the substrate 20 with the coating composition to form a liquid film and drying the liquid film is longer than that in the related art, as described below. The liquid film after coating is thus levelled, and the coating film 10 is formed in this state. As a result, the coating film 10 with smoothed surface roughness is obtained, and the coating film 10 has higher transparency than that in the related art.

The coating film 10 preferably has a film thickness of 20 nm or more and 250 nm or less. When the film thickness is less than 20 nm, the coating film is too thin to obtain desired soil resistance. When the film thickness is more than 250 nm, the coating film 10 may have large surface roughness and may be whitish. For the above reasons, the coating film 10 preferably has a film thickness of 20 nm or more and 250 nm or less. When the coating film 10 has a film thickness of 80 nm or more and 150 nm or less, particularly about 100 nm, the coating film 10 can be provided with an anti-reflection function, and the transmittance of the substrate 20 to be coated with the coating film 10 can be improved.

FIG. 2 describes the advantageous effect of the coating film composed of the coating composition according to Embodiment 1. FIG. 2a illustrates direct attachment of the organic substance, which causes clouding due to the fogging phenomenon, with no coating film applied onto the substrate, such as glass. The organic substance 18 causing clouding due to the fogging phenomenon is attached, in the form of fine droplets, to the surface of the substrate 20, and the fine droplets scatter light to make the film whitish.

FIG. 2b illustrates attachment of the organic substance 18, which causes clouding due to the fogging phenomenon, while a film composed only of silica fine particles is formed on the substrate as an example coating film composed of a coating composition known in the related art. The organic substance 18 is absorbed by the silica fine particle layer 11 and does not generate droplets on the substrate, resulting in no large light scattering, unlike FIG. 2a. In FIG. 2b, however, there is a large difference in refractive index between a portion 21b that absorbs the organic substance 18, that is, a portion adjacent to the outermost surface of the film, and a portion 22b that does not absorb the organic substance 18, that is, a portion adjacent to the substrate. This configuration generates uneven transmittance to impair transparency or generates glare. The film composed only of the silica fine particles is a porous film, and the film thus has a refractive index corrected for air. The portion 21b, which absorbs the organic substance 18, in FIG. 2b has a refractive index corrected for the organic substance. There is thus a large difference in refractive index between the portion 21b, which absorbs the organic substance 18, and the portion 22b, which does not absorb the organic substance 18, in FIG. 2b. There is also a problem in which the transmittance of the coating film varies when portions with different amounts of absorption of the organic substance 18 are generated by, for example, differences in the conditions of exposure to the organic substance, such as airflow, or differences in the temperature of the substrate.

FIG. 2c illustrates attachment of the organic substance 18, which causes clouding due to the fogging phenomenon, to the coating film composed of the coating composition according to Embodiment 1. Since the coating film composed of the coating composition according to Embodiment 1 contains the metal oxide fine particles having a high refractive index, the film has a higher refractive index than the coating film composed only of silica fine particles in the related art described in FIG. 2b, that is, has a refractive index close to the refractive index of the organic substance. There is thus a smaller difference in refractive index between a portion 21c that absorbs the organic substance 18, that is, a portion adjacent to the outermost surface of the film, and a portion 22c that does not absorb the organic substance 18, that is, a portion adjacent to the substrate, in FIG. 2c than that in the film composed only of silica fine particles described in FIG. 2b. Thus, the uneven absorption of the organic substance 18 does not affect visibility, and the coating film maintains high transparency and uniformity.

### Substrate

The substrate is a part on which the coating film is to be formed. In an example, the substrate is a part included in an article. The substrate may be made of transparent glass or transparent plastic. In the case of forming the coating film on a transparent substrate, the substrate can keep its transparency, and the anti-reflection effect can also be obtained by appropriately designing the film thickness of the coating film to improve light transmittance. In the case of forming the coating film on a non-transparent substrate, there is an advantage in that the substrate can be treated to prevent changes in color tone. For a glossy surface, the anti-reflection effect described above provides the effect of improving color depth or brightness. Since the clouding due to the fogging phenomenon is noticeable on a high-gloss surface, the formation of the coating film composed of the coating composition according to Embodiment 1 on a substrate surface with a 60 degree specular gloss of 50 or more tends to be particularly effective in prevention or reduction of substrate clouding caused by the fogging phenomenon. For a black or other colored substrate, the formation of the coating film composed of the coating composition according to Embodiment 1 on the substrate surface tends to be particularly effective in prevention or reduction of the fogging phenomenon regardless of glossiness. For a transparent or white substrate with a low-gloss surface, the clouding due to the fogging phenomenon is originally less noticeable even when the clouding occurs.

### Production Method

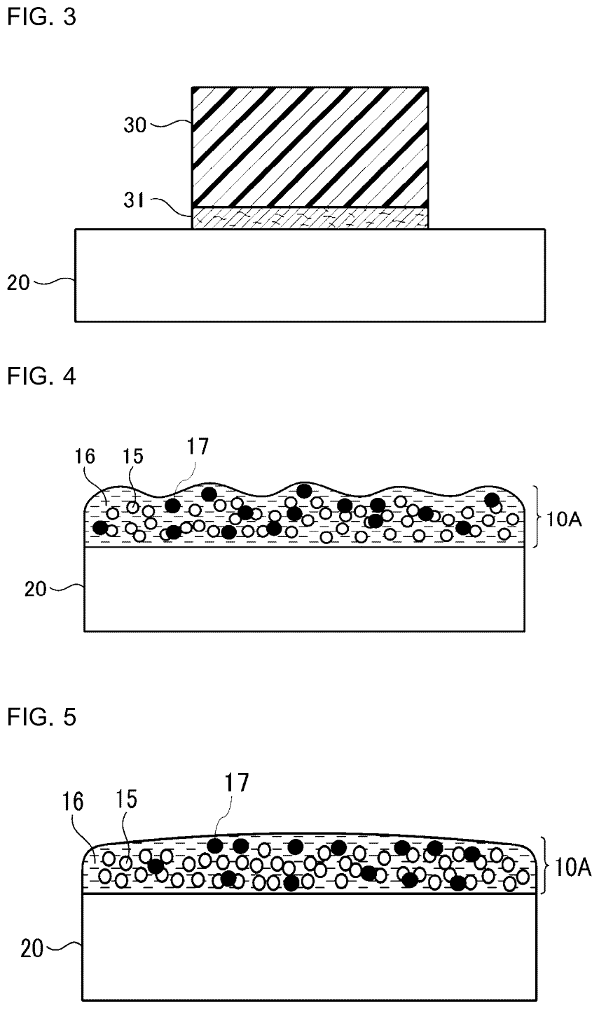

FIG. 3 is a cross-sectional view schematically illustrating an example method for producing the coating film composed of the coating composition according to Embodiment 1. A cloth 31 impregnated with the coating composition is fixed to a block 30, which is a coater. A surface of the block 30 to which the cloth 31 is fixed is brought into close contact with the substrate 20 and slid on the substrate 20 so that the coating composition is applied onto the substrate 20. This process forms a liquid film composed of the coating composition on the substrate 20. A combination of the cloth 31 and the block 30 enables application of a small amount of the coating composition onto the substrate 20 with a uniform pressure on the cloth 31 to form a uniform coating film.

The cloth 31 preferably has a thickness of 5 mm or less. When the thickness is larger than 5 mm, the impregnation amount of the coating composition is too large to perform uniform coating. The cloth 31 refers to accumulates of fibers, such as woven fabric, non-woven fabric, and paper. The material of the cloth 31 is not limited as long as the material can be impregnated with the coating composition. An example of the cloth 31 is rayon cloth. Since generation of fiber waste causes coating defects, the cloth 31 preferably contains as few short fibers as possible.

The block 30 has any shape, but preferably has a shape that is slidable on the surface of the substrate 20. In other words, the block 30 having a surface shaped along the surface of the substrate 20 is preferably used.

The block 30 is made of any material. In an example, the material of the block 30 is polycarbonate. Alternatively, the block 30 may be made of a material that can be impregnated with the coating composition. Sponges of various materials having open pores can be used as the block 30, and the sponges preferably have a pore size of 0.05 mm or more and 2 mm or less, more preferably have a pore size of 0.1 mm or more and 1.5 mm or less. When the pore size is less than 0.05 mm, it is difficult to apply a sufficient amount of the coating composition. When the pore size is more than 2 mm, the amount of the applied coating composition is so large that the liquid film tends to have unevenness, which is not preferred. For the above reasons, the sponges preferably have a pore size of 0.05 mm or more and 2 mm or less.

The coating method described above is a method for stably applying the coating composition to a wide area. The coating method may be other methods, such as dipping coating, brush coating, spray coating, and coating by use of various coaters. The coating composition can also be applied to the substrate 20 by pouring the coating composition.

FIG. 4 to FIG. 6 are cross-sectional views schematically illustrating example steps in the method for producing the coating film composed of the coating composition according to Embodiment 1. First, a liquid film forming step for applying the coating composition onto the substrate 20 to form a liquid film is performed. FIG. 4 illustrates the initial state of a liquid film 10A just after applying the coating composition onto the substrate 20. As illustrated in FIG. 4, the liquid film 10A composed of the applied coating composition has uneven thickness in the initial state. In the liquid film 10A, the silica fine particles 15 and the metal oxide fine particles 17 are dispersed in a solvent 16 without aggregation. Next, a drying step for drying the liquid film 10A in this state is performed.

Since the coating composition according to Embodiment 1 contains a high-boiling point solvent, the solvent 16 in the coating composition does not volatilize just after application, and the solvent 16 volatilizes over time according to the amount of the high-boiling point solvent. As illustrated in FIG. 5, the liquid film 10A is gradually levelled during this time so that the upper surface of the liquid film 10A becomes flat. At this time, the silica fine particles 15 and the metal oxide fine particles 17 are maintained in the dispersed state in the liquid film 10A without aggregation.

Thereafter, the solvent 16 is finally dried, and the silica fine particles 15 and the metal oxide fine particles 17 aggregate with each other to form the coating film 10 having the silica fine particle layer 11, as illustrated in FIG. 6.

In the method for drying the coating composition, it is important to prevent temperature unevenness on the surface of the applied liquid film 10A. Preferably, the coating composition is naturally dried after application. To accelerate drying with airflow, it is preferred not to use an airflow with a temperature 15 degrees or more higher than the temperature of the substrate 20. When the airflow with a temperature 15 degrees or more higher than the temperature of the substrate 20 is used, the temperature unevenness is generated on the surface of the applied liquid film 10A, and the unevenness is also generated in the coating film 10 obtained after drying. The rate of the airflow is not limited, but preferably 25 m/sec or less. The airflow at a rate of more than 25 m/sec may disturb the liquid film 10A before drying and may not provide the uniform coating film 10.

The coating composition according to Embodiment 1 includes the silica fine particles, the metal oxide fine particles, the high-boiling point solvent, and water. The silica fine particles have an average particle size of 3 nm or more and 25 nm or less, and the amount of the silica fine particles in the coating composition is 0.1 mass % or more and 5 mass % or less. The high-boiling point solvent has a boiling point of 150 degrees C. or higher and 300 degrees C. or lower, and the amount of the high-boiling point solvent in the coating composition is 20 mass % or more and 70 mass % or less. When an organic substance causing clouding due to the fogging phenomenon is attached to the coating film composed of the coating composition of Embodiment 1, the organic substance permeates the silica fine particles. This can readily eliminate clouding, and the coating film can maintain transparency. Since the metal oxide fine particles are contained in the coating composition, the uneven absorption of the organic substance 18 does not affect visibility, and the coating film maintains high transparency.

### Embodiment 2

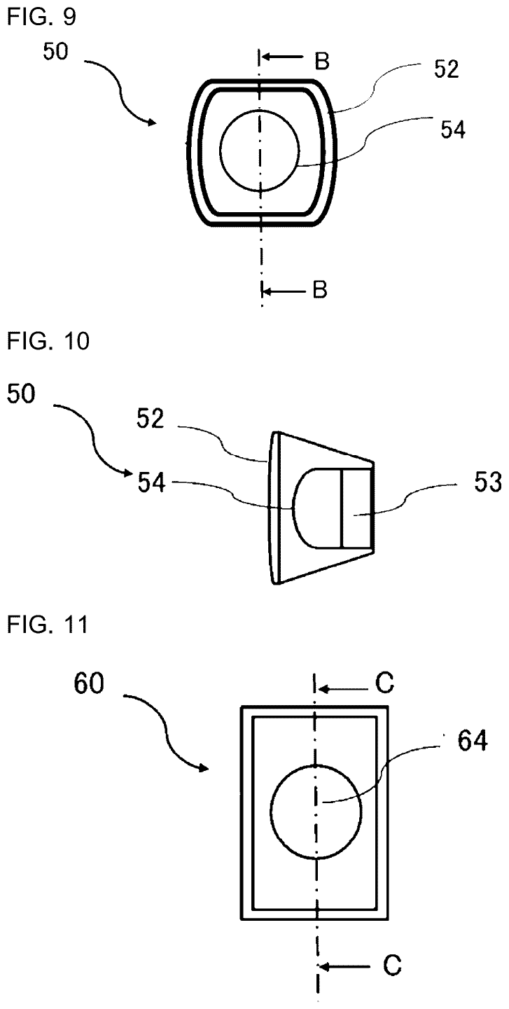

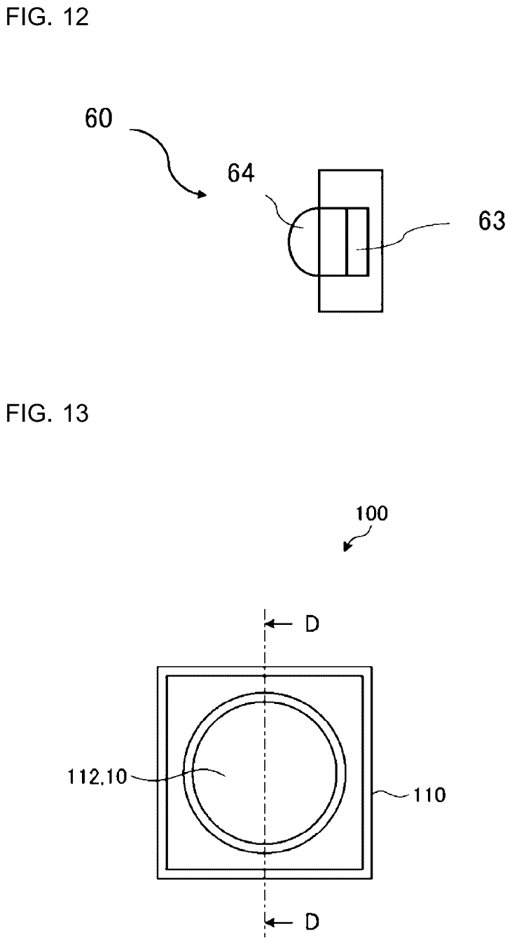

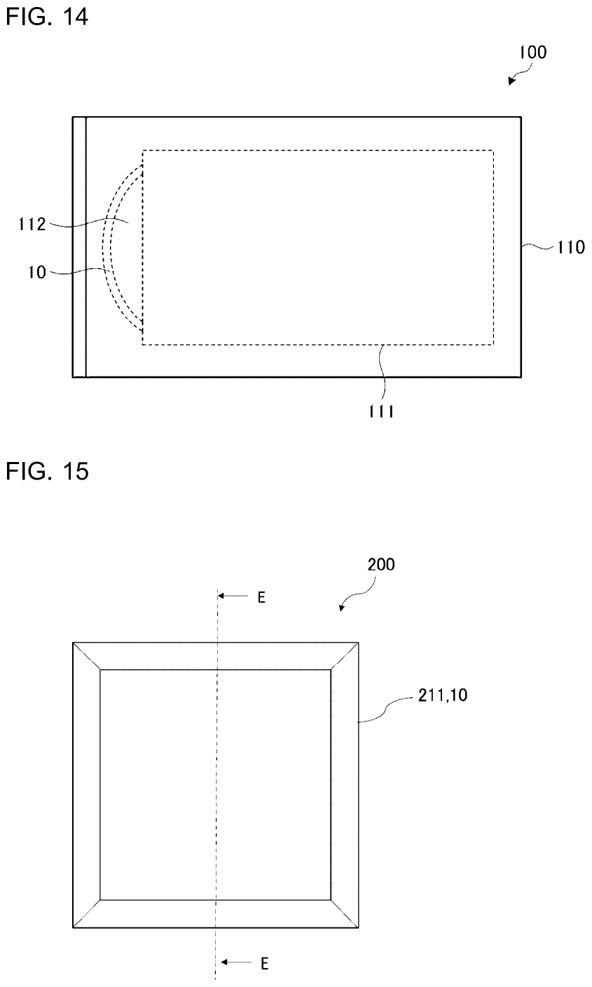

Embodiment 2 describes formation of the coating film composed of the coating composition described in Embodiment 1 on an optical device, which is an article. FIG. 7 to FIG. 14 are views of example optical devices having the coating film according to Embodiment 2. In FIG. 7 to FIG. 12 among these figures, headlights 40, 50, and 60 are illustrated as example optical devices. In FIG. 13 and FIG. 14, a camera 100 is illustrated as an example optical device. FIG. 7 is a front view of the headlight 40 having a reflector, which is an example optical device having the coating film according to Embodiment 2, and FIG. 8 is a cross-sectional view taken along line A-A in FIG. 7. FIG. 9 is a front view of the headlight 50 having a lens and an outer, which is an example optical device having the coating film according to Embodiment 2. FIG. 10 is a cross-sectional view taken along line B-B in FIG. 9. FIG. 11 is a front view of the headlight 60, which is an example optical device having the coating film according to Embodiment 2. FIG. 12 is a cross-sectional view taken along line C-C in FIG. 11. FIG. 13 is a front view of the camera 100, which is an example optical device having the coating film according to Embodiment 2. FIG. 14 is a cross-sectional view taken along line D-D in FIG. 13.

As illustrated in FIG. 7 to FIG. 14, the headlights have a light source 43, 53, or 63. With regard to other components, the headlight 40 has a reflector 41 inside an outer 42 covering the light source, the headlight 50 has a lens 54 covered with an outer 52, and the headlight 60 has no outer and an exposed lens 64. Since headlights are sealed and reach high temperatures, organic substances may volatilize from parts inside headlights to cause clouding on the inner side of outers or the surface of lenses, that is, clouding due to the fogging phenomenon. To solve this issue, the coating film 10 is formed on the inner side of the outers of the headlights or on the surfaces of the lenses to maintain transparency without clouding due to the fogging phenomenon.

The coating film 10 formed on the outer side of the outers or on the surface of the exposed lens can provide a hydrophilic effect. When water droplets attach to the surface, the water droplets may serve as lenses to change luminous intensity distribution. As long as the surface is hydrophilic, water spreads, and no water droplets are formed, so that the luminous intensity distribution can be maintained. The coating film formed on the outer side of the outers or on the surface of the exposed lens can provide the effect of soil resistance and can prevent changes in luminous intensity distribution caused by dirt. In addition, the transmittance of parts coated with the coating film can also be improved by adjusting the film thickness of the coating film such that the coating film has an anti-reflection function.

The camera 100 includes a camera body 111 and a lens 112 inside a housing 110. When the camera 100 is used outdoors, dirt may attach to the surface of the lens 112. The coating film 10 described in Embodiment 1 formed on the surface of the lens 112 can prevent attachment of dirt for a long time without affecting images captured by the camera 100.

In Embodiment 2, the coating film 10 is formed on the lens 112 of the camera 100. Since the coating film 10 has higher transparency than coating films known in the related art, the light focus performance of the lens 112 equivalent to that before coating with the coating film 10 can be expected. In addition, the transmittance of the lens 112 coated with the coating film 10 can also be improved by adjusting the film thickness of the coating film 10 such that the coating film 10 has an anti-reflection function.

### Embodiment 3

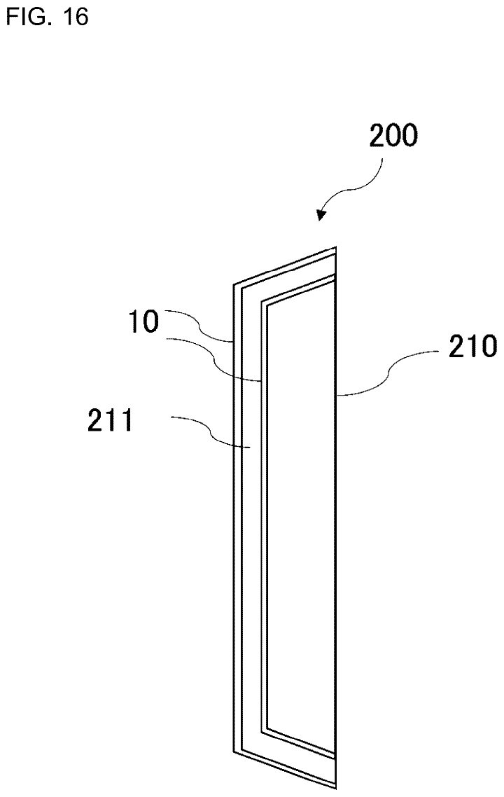

Embodiment 3 describes formation of the coating film composed of the coating composition described in Embodiment 1 on a lighting device, which is an article. FIG. 15 is a front view of an example lighting device having the coating film according to Embodiment 3. FIG. 16 is a cross-sectional view taken along line E-E in FIG. 15. In Embodiment 3, a lighting device 200 includes a body 210 emitting light and a lighting cover 211 covering the body 210.

Thermal decomposition products or compounds may volatilize from parts of the lighting device 200 and attach to the inner side of the lighting cover 211 to generate clouding due to the fogging phenomenon. Volatile organic substances found in the environment may attach to the outer side of the lighting cover 211 to generate clouding due to the fogging phenomenon. The coating film composed of the coating composition described in Embodiment 1 formed on the inner side or the outer side of the lighting cover 211 can prevent or reduce generation of clouding to maintain transparency for a long time. The coating film composed of the coating composition described in Embodiment 1 formed on the outer side of the lighting cover 211 can provide the effect of soil resistance against dust or other contaminants from outside.

### EXAMPLES

The details of the present disclosure will be described below with reference to Examples and Comparative Examples, but the present disclosure is not limited by these Examples.

### Method for Preparing Coating Composition, and Method for Forming Coating Film

### Example 1

A colloidal silica containing silica fine particles with an average particle size of 12 nm (available from Nissan Chemical Corporation, NH4+stable alkaline sol, ST-N), a tin oxide sol containing tin oxide fine particles, which are metal oxide fine particles having an average particle size of 2 nm (available from Taki Chemical Co., Ltd., ceramace S-8), diethylene glycol monobutyl ether with a boiling point of 230 degrees C., which is used as a high-boiling point solvent, and deionized water, which is used as water, are blended and mixed with stirring the components to prepare a coating composition. In the coating composition, the amount of the silica fine particles is 1 mass %, the amount of the tin oxide fine particles is 0.2 mass %, the amount of diethylene glycol monobutyl ether is 50 mass %, and the balance is deionized water.

A non-woven fabric (available from Kuraray Kuraflex Co., Ltd., product name: Kuraclean (registered trademark) Wiper, fiber used: rayon) is impregnated with the prepared coating composition and fixed to a polycarbonate block. The surface of the non-woven fabric is brought into close contact with a glass substrate (50 mm×50 mm×1 mm) and slid on the glass substrate. The coating composition is then dried at 25 degrees C. for 24 hours to form a coating film.

### Example 2

A coating composition is prepared in the same manner as in Example 1 except that the amount of diethylene glycol monobutyl ether, which is a high-boiling point solvent, is changed to 20 mass %. A coating film is formed on a glass substrate in the same manner as in Example 1.

### Example 3

A coating composition is prepared in the same manner as in Example 1 except that the amount of diethylene glycol monobutyl ether, which is a high-boiling point solvent, is changed to 21 mass %. A coating film is formed on a glass substrate in the same manner as in Example 1.

### Example 4

A coating composition is prepared in the same manner as in Example 1 except that the amount of diethylene glycol monobutyl ether, which is a high-boiling point solvent, is changed to 55 mass %. A coating film is formed on a glass substrate in the same manner as in Example 1.

### Example 5

A coating composition is prepared in the same manner as in Example 1 except that the amount of diethylene glycol monobutyl ether, which is a high-boiling point solvent, is changed to 69 mass %. A coating film is formed on a glass substrate in the same manner as in Example 1.

### Example 6

A coating composition is prepared in the same manner as in Example 1 except that the amount of diethylene glycol monobutyl ether, which is a high-boiling point solvent, is changed to 70 mass %. A coating film is formed on a glass substrate in the same manner as in Example 1.

### Example 7

A coating composition is prepared in the same manner as in Example 1 except that dipropylene glycol dimethyl ether with a boiling point of 171 degrees C. is used instead of diethylene glycol monobutyl ether, which is a high-boiling point solvent. A coating film is formed on a glass substrate in the same manner as in Example 1.

### Example 8

A coating composition is prepared in the same manner as in Example 1 except that the amount of the silica fine particles is changed to 0.2 mass %. A coating film is formed on a glass substrate in the same manner as in Example 1.

### Example 9

A coating composition is prepared in the same manner as in Example 1 except that the amount of the silica fine particles is changed to 4 mass %. A coating film is formed on a glass substrate in the same manner as in Example 1.

### Example 10

A coating composition is prepared in the same manner as in Example 1 except that the average particle size of the silica fine particles is changed to 5 nm. A coating film is formed on a glass substrate in the same manner as in Example 1.

### Example 11

A coating composition is prepared in the same manner as in Example 1 except that the average particle size of the silica fine particles is changed to 20 nm. A coating film is formed on a glass substrate in the same manner as in Example 1.

### Example 12

A coating composition is prepared in the same manner as in Example 1 except that the amount of the tin oxide fine particles is changed to 0.7 mass %. A coating film is formed on a glass substrate in the same manner as in Example 1.

### Example 13

A coating composition is prepared in the same manner as in Example 1 except that the tin oxide sol is changed to a zirconium oxide dispersion containing zirconium oxide with an average particle size of 10 nm (available from Sakai Chemical Industry Co., Ltd., SZR-GCW). A coating film is formed on a glass substrate in the same manner as in Example 1.

### Example 14

A coating composition is prepared in the same manner as in Example 1 except that the tin oxide sol is changed to a cerium oxide sol with an average particle size of 8 nm (available from Taki Chemical Co., Ltd., B-10). A coating film is formed on a glass substrate in the same manner as in Example 1.

### Example 15

A coating composition is prepared in the same manner as in Example 1 except that 10 mass % of PTFE particles (available from DuPont Mitsui Fluorochemicals Co., Ltd., product name: 31JR) relative to the silica fine particles is added as fluororesin particles. The PTFE particles have an average particle size of 0.25 μm. A coating film is formed on a glass substrate in the same manner as in Example 1.

### Example 16

A coating composition is prepared in the same manner as in Example 1 except that 40 mass % of PTFE particles (available from DuPont Mitsui Fluorochemicals Co., Ltd., product name: 31JR) relative to the silica fine particles is added as fluororesin particles. The PTFE particles have an average particle size of 0.25 μm. A coating film is formed on a glass substrate in the same manner as in Example 1.

### Example 17

A coating composition is prepared in the same manner as in Example 1 except that 15 mass % of polyethylene glycol (available from Tokyo Chemical Industry Co., Ltd., product name: Polyethylene Glycol 400) relative to the silica fine particles is added as a non-volatile hydrophilic organic substance. The polyethylene glycol has an average molecular weight of 380 or more and 420 or less. A coating film is formed on a glass substrate in the same manner as in Example 1.

### Example 18

A coating composition is prepared in the same manner as in Example 1 except that 35 mass % of polyethylene glycol (available from Tokyo Chemical Industry Co., Ltd., product name: Polyethylene Glycol 400) relative to the silica fine particles is added as a non-volatile hydrophilic organic substance. The polyethylene glycol has an average molecular weight of 380 or more and 420 or less. A coating film is formed on a glass substrate in the same manner as in Example 1.

### Example 19

A coating film is formed in the same manner as in Example 1 except that the coating composition of Example 1 is applied to an acrylic substrate (Acrylonitrile Butadiene Styrene (ABS), 50 mm×50 mm×2 mm).

### Example 20

The coating composition of Example 1 is applied to a glass substrate (50 mm×50 mm×1 mm) by spray coating and then dried at 25 degrees C. for 24 hours to form a coating film.

### Comparative Example 1

A coating composition is prepared in the same manner as in Example 1 except that the amount of diethylene glycol monobutyl ether, which is a high-boiling point solvent, is changed to 15 mass %. A coating film is formed on a glass substrate in the same manner as in Example 1.

### Comparative Example 2

A coating composition is prepared in the same manner as in Example 1 except that the amount of diethylene glycol monobutyl ether, which is a high-boiling point solvent, is changed to 19 mass %. A coating film is formed on a glass substrate in the same manner as in Example 1.

### Comparative Example 3

A coating composition is prepared in the same manner as in Example 1 except that the amount of diethylene glycol monobutyl ether, which is a high-boiling point solvent, is changed to 71 mass %. A coating film is formed on a glass substrate in the same manner as in Example 1.

### Comparative Example 4

A coating composition is prepared in the same manner as in Example 1 except that the amount of diethylene glycol monobutyl ether, which is a high-boiling point solvent, is changed to 75 mass %. A coating film is formed on a glass substrate in the same manner as in Example 1.

### Comparative Example 5

A coating composition is prepared in the same manner as in Example 1 except that ethanol with a boiling point of 87 degrees C. is used instead of diethylene glycol monobutyl ether, which is a high-boiling point solvent. A coating film is formed on a glass substrate in the same manner as in Example 1.

### Comparative Example 6

A coating composition is prepared in the same manner as in Example 1 except that the silica fine particles are changed to lithium silicate (available from Nissan Chemical Corporation, product name: Lithium Silicate 45). A coating film is formed on a glass substrate in the same manner as in Example 1.

### Comparative Example 7

A coating composition is prepared in the same manner as in Example 1 except that the average particle size of the silica fine particles is changed to 30 nm. A coating film is formed on a glass substrate in the same manner as in Example 1.

### Comparative Example 8

A coating composition is prepared in the same manner as in Example 1 except that the amount of the silica fine particles is changed to 0.05 mass %. A coating film is formed on a glass substrate in the same manner as in Example 1.

### Comparative Example 9

A coating composition is prepared in the same manner as in Example 1 except that the amount of the silica fine particles is changed to 7 mass %. A coating film is formed on a glass substrate in the same manner as in Example 1.

### Comparative Example 10

A coating composition is prepared in the same manner as in Example 1 except that no tin oxide fine particles are added. A coating film is formed on a glass substrate in the same manner as in Example 1.

### Comparative Example 11

A coating composition is prepared in the same manner as in Example 1 except that 60 mass % of PTFE particles (available from DuPont Mitsui Fluorochemicals Co., Ltd., product name: 31JR) relative to the silica fine particles are added as fluororesin particles. The PTFE particles have an average particle size of 0.25 μm. A coating film is formed on a glass substrate in the same manner as in Example 1.

### Comparative Example 12

A coating composition is prepared in the same manner as in Example 1 except that 50 mass % of polyethylene glycol (available from Tokyo Chemical Industry Co., Ltd., product name: Polyethylene Glycol 400) relative to the silica fine particles is added as a non-volatile hydrophilic organic substance. The polyethylene glycol has an average molecular weight of 380 or more and 420 or less. A coating film is formed on a glass substrate in the same manner as in Example 1.

### Method for Evaluating Coating Film

The film thicknesses of the coating films composed of the coating compositions of Examples 1 to 20 and Comparative Examples 1 to 12 are measured, and the coating films are evaluated for transparency, fogging resistance, appearance after fogging testing, and furthermore, transparency and soil resistance.

### Measurement of Film Thickness

Part of the coating film formed on the substrate is scraped off, and a difference in level between the coating film and the substrate is measured by use of a 3D measuring laser microscope (available from Olympus Corporation) to determine the film thickness. The measurement results of the film thicknesses of the coating films are classified according to the following criteria.
1: The film thickness is less than 20 nm.
2: The film thickness is 20 nm or more and 250 nm or less.
3: The film thickness is more than 250 nm.

### Evaluation of Transparency

The clarity of the coating film is measured by use of haze-gard i (available from BYK). The measurement results of the clarity of the coating films are classified according to the following criteria, and the coating films with a clarity of 90% or more are rated as high in transparency.
1: The clarity is 95% or more.
2: The clarity is less than 95% and 90% or more.
3: The clarity is less than 90%.

### Evaluation of Fogging Resistance

In a glass bottle with a diameter of 9 cm and a height of 19 cm, 1 mL of bis(2-ethylhexyl) phthalate is placed. The mouth of the glass bottle is covered with a coated sample plate. The bottom of the glass bottle is heated in a water bath at 80 degrees C. for 30 minutes. The haze of the sample plate is then measured by use of haze-gard i (available from BYK) and compared with the initial value before fogging testing. The coating films with a difference in haze ΔHaze of less than 4 are rated as high in fogging resistance.
1: ΔHaze is less than 2.
2: ΔHaze is 3 or more and less than 7.
3: ΔHaze is 7 or more.

### Evaluation of Appearance after Fogging Testing

The clarity of the coating films after fogging testing is measured by use of haze-gard i (available from BYK). The measurement results of the clarity of the coating film are evaluated according to the following criteria, and the coating films with a clarity of 90% or more are rated as high in transparency.
1: The clarity is 95% or more.
2: The clarity is less than 95% and 90% or more.
3: The clarity is less than 90% or more.

### Evaluation of Soil Resistance

The adherence of dust that is a hydrophilic contaminant to the coating films is evaluated as soil resistance. Specifically, Kanto loam dust, which is a Japanese Industrial Standards (JIS) test powder having a median particle size in the range of 1 um or more and 3 μm or less, is sprayed onto the coating films with air under the conditions of a temperature of 25 degrees C. and a humidity of 50%. Thereafter, Kanto loam dust on the coating films is transferred to a mending tape (available from Sumitomo 3M Limited). The absorbance at a wavelength of 550 nm on another transparent substrate on which the tape having the dust transferred the tape is attached is measured by use of a spectrophotometer (available from Shimadzu Corporation, product name: UV-3100PC). The absorbance is evaluated according to the following criteria, and the coating films with an absorbance of less than 0.3 are rated as high in soil resistance.
1: The absorbance is less than 0.2.
2: The absorbance is 0.2 or more and less than 0.3.
3: The absorbance is 0.3 or more.

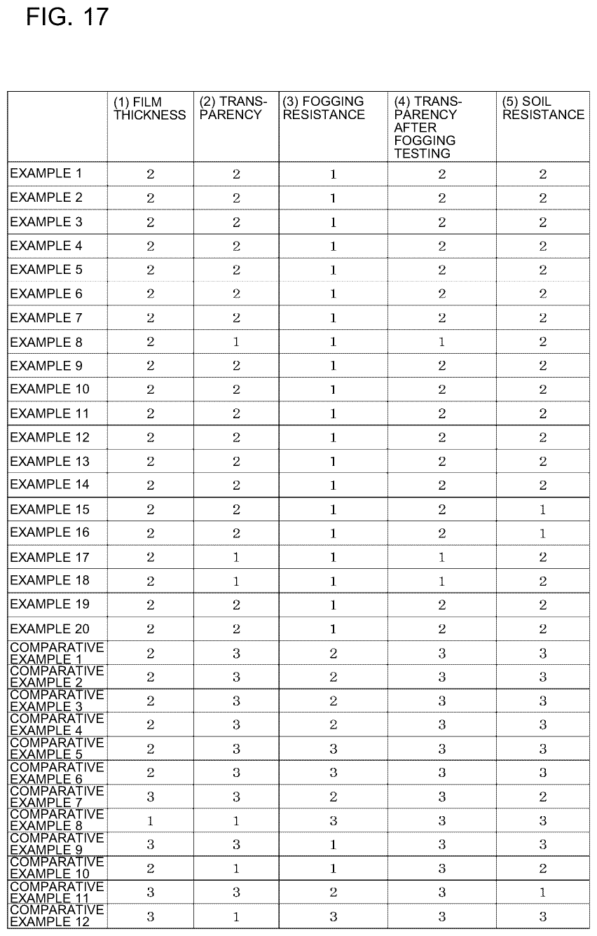

FIG. 17 illustrates the summery of the evaluation results of Examples 1 to 20 and Comparative Examples 1 to 12. As illustrated in FIG. 17, the silica fine particles in the coating compositions of Examples 1 to 14 have an average particle size in the range of 3 nm or more and 25 nm or less, and the amount of the silica fine particles in the coating compositions is in the range of 0.1 mass % or more and 5 mass % or less. The coating compositions of Examples 1 to 14 contain metal oxide fine particles. The high-boiling point solvents in the coating compositions of Examples 1 to 14 have a boiling point in the range of 150 degrees C. or higher and 300 degrees C. or lower, and the amount of the high-boiling point solvent in each coating composition is in the range of 20 mass % or more and 70 mass % or less. Therefore, the coating films formed by use of these coating compositions have high transparency, high fogging resistance, high transparency after fogging testing, and high soil resistance.

The coating compositions of Examples 15 and 16 contain 5 mass % or more and 50 mass % or less of the fluororesin particles relative to the silica fine particles and thus have high transparency, high fogging resistance, good appearance after fogging testing, and high soil resistance. Similarly, the coating compositions of Examples 17 and 18 contain 10 mass % or more and 40 mass % or less of the non-volatile hydrophilic organic substance relative to the silica fine particles and thus have high transparency, high fogging resistance, high transparency after fogging testing, and high soil resistance.

Furthermore, the coating film formed on the acrylic substrate in Example 19, and the coating film formed by spray coating in Example 20 also have high transparency, high fogging resistance, good appearance after fogging testing, and high soil resistance. In other words, the coating films have high transparency, high fogging resistance, high transparency after fogging testing, and high soil resistance regardless of whether the substrate is glass or acrylic. The coating film formed by coating by use of a non-woven fabric and the coating film formed by spray coating both have high transparency, high fogging resistance, high transparency after fogging testing, and high soil resistance.

In contrast, the coating films of Comparative Examples 1 and 2 are rated as low in transparency, transparency after fogging testing, and soil resistance. This may be because the amount of the high-boiling point solvent added is not enough to sufficiently obtain the effect of forming a uniform film. The coating films of Comparative Examples 3 and 4 are rated as low in transparency, transparency after fogging testing, and soil resistance. This may be because the amount of the high-boiling point solvent added is so large that the dispersibility of the silica fine particles and the metal oxide decreases to increase the surface roughness of the coating films.

The coating film of Comparative Example 5 is rated as low in transparency, fogging resistance, transparency after fogging testing, and soil resistance. This may be because ethanol used as a solvent has a boiling point of 87 degrees C., which is lower than the boiling points of other high-boiling point solvents. The coating film of Comparative Example 6 is a dense film and is thus rated as low in transparency, fogging resistance, transparency after fogging testing, and soil resistance. The coating film of Comparative Example 7 has silica fine particles with excessively large particle size and is thus rated as low in transparency, transparency after fogging testing, and soil resistance. The coating film of Comparative Example 8 is a thin film with a small amount of the silica fine particles added and is thus rated as low in fogging resistance, transparency after fogging testing, and soil resistance. The coating film of Comparative Example 9 is a thick film with a large amount of the silica fine particles added and is thus rated as low in transparency, transparency after fogging testing, and soil resistance. The coating film of Comparative Example 10 is rated as low in transparency after fogging testing. This is because the coating film contains no metal oxide, so that the unevenness generated by permeation of the organic substance causing fogging is noticeable. The coating film of Comparative Example 11 is rated as low in transparency and transparency after fogging testing. This may be because excessive addition of the fluororesin particles causes the coating film to have large roughness and appear whitish. The coating film of Comparative Example 12 is rated as low in fogging resistance, transparency after fogging testing, and soil resistance. This may be because excessive addition of the non-volatile hydrophilic organic substance reduces the effect of permeation of the organic substance causing fogging and even increases attachment of dirt.

### Examples for Applying Coating Composition to Articles

### Example 21

A non-woven fabric (available from Kuraray Kuraflex Co., Ltd., product name: Kuraclean Wiper, fiber used: rayon) is impregnated with the coating composition of Example 1. The non-woven fabric is brought into close contact with and sild on the inner side of the outer of a headlight to apply the coating composition. The coating composition is then naturally dried at 25 degrees C. for 24 hours to form a coating film.

### Example 22

The coating composition of Example 1 is applied to the inner side of the cover of a glass light fixture by spray coating and naturally dried at 25 degrees C. for 24 hours.

In Examples 21 and 22, a coating film is formed on the substrate, but the appearance of the substrate does not change. In other words, the coating films formed in Examples 21 and 22 have high transparency.

In a glass bottle with a diameter of 9 cm and a height of 19 cm, 1 mL of bis (2-ethylhexyl) phthalate is placed. The cut substrate is fixed to an upper part of the glass bottle, and the glass bottle is sealed. The bottom of the glass bottle is heated in a water bath at 80 degrees C. for 30 minutes, and the haze of the substrate is then measured. The haze is determined to be 5% or less as measured by use of haze-gard i (available from BYK-Gardner), which shows that the coating films have high fogging resistance. Furthermore, Kanto loam dust, which is a JIS test powder having a median particle size in the range of 1 μm or more and 3 μm or less, is sprayed with air under the conditions of a temperature of 25 degrees C. and a humidity of 50%, and each article is then lightly vibrated. As a result, dust falls from the articles having the coating films of Examples 21 and 22 formed on the articles, which shows that the coating films formed in Examples 21 and 22 have high soil resistance.

The configurations in Embodiments described above illustrate examples and can be combined with other known techniques, can be combined with each other, or can be partially omitted or changed without departing from the gist of the present disclosure.

### REFERENCE SIGNS LIST

10: coating film, 10A: liquid film, 11: silica fine particle layer, 12: fluororesin particle, 13: crack, 14: non-volatile hydrophilic organic substance, 15: silica fine particle, 16: solvent, 17: metal oxide fine particle, 18: organic substance causing clouding, 20: substrate, 21b: a portion of a film composed only of silica fine particles that absorbs an organic substance, 21c: a portion of a coating film that absorbs an organic substance, 22b: a portion of a film composed only of silica fine particles that does not absorb an organic substance, 22c: a portion of a coating film that does not absorb an organic substance, 30: block, 31: cloth, 40: headlight having a reflector, 41: reflector, 42, 52: outer, 43, 53, 63: light source, 50 headlight having a lens and an outer, 54, 64: lens, 60: headlight having a lens, 100: camera, 110, 310: housing, 111: camera body, 112: lens, 200: lighting device, 210: body, 211: lighting cover

1. A coating composition comprising:
silica fine particles having an average particle size of 3 nm or larger and 25 nm or smaller;
metal oxide fine particles;
a solvent having a boiling point of 150 degrees C. or higher and 300 degrees C. or lower; and
water,
an amount of the silica fine particles being 0.1 mass % or more and 5 mass % or less,
an amount of the solvent being 20 mass % or more and 70 mass % or less,
an amount of the metal oxide fine particles being 2 mass % or more and 80 mass % or less relative to the silica fine particles,
the metal oxide fine particles having an average particle size of 1 nm or more and 25 nm or less.

2. (canceled)

3. The coating composition of claim 1, further comprising fluororesin particles in an amount of 5 mass % or more and 50 mass % or less relative to the silica fine particles.

4. The coating composition of claim 1, further comprising a non-volatile hydrophilic organic substance, which is an organic substance that is not volatile and has hydrophilicity, in an amount of 10 mass % or more and 40 mass % or less relative to the silica fine particles.

5. A coating film composed of the coating composition of claim 1 and formed on a substrate, the coating film comprising a silica fine particle layer disposed on the substrate and formed by aggregation of the silica fine particles and the metal oxide fine particles.

6. A coating film composed of the coating composition of claim 3 and formed on a substrate, the coating film comprising a silica fine particle layer disposed on the substrate and formed by aggregation of the silica fine particles and the metal oxide fine particles,
wherein the fluororesin particles are partially exposed on a surface of the coating film and dispersed in the silica fine particle layer.

7. A coating film composed of the coating composition of claim 4 and formed on a substrate, the coating film comprising a silica fine particle layer disposed on the substrate and formed by aggregation of the silica fine particles and the metal oxide fine particles,
wherein the non-volatile hydrophilic organic substance fills defects in the silica fine particle layer.

8. The coating film of claim 5, wherein the coating film has a film thickness of 20 nm or more and 250 nm or less.

9. The coating film of claim 5, wherein the substrate has a surface with a 60 degree specular gloss of 50 or more.

10. An article comprising the coating film of claim 5.

11. An optical device including an outer, the optical device comprising the coating film of claim 5 on one or both of an outer surface and an inner surface of the outer.

12. An optical device including a lens, the optical device comprising the coating film of claim 5 on a surface of the lens.

13. A lighting device including a lighting cover, the lighting device comprising the coating film of claim 5 on one or both of an outer surface and an inner surface of the lighting cover.

14. An article comprising the coating film of claim 6.

15. An article comprising the coating film of claim 7.

16. An optical device including an outer, the optical device comprising the coating film of claim 6 on one or both of an outer surface and an inner surface of the outer.

17. An optical device including an outer, the optical device comprising the coating film of claim 7 on one or both of an outer surface and an inner surface of the outer.

18. An optical device including a lens, the optical device comprising the coating film of claim 6 on a surface of the lens.

19. An optical device including a lens, the optical device comprising the coating film of claim 7 on a surface of the lens.

20. A lighting device including a lighting cover, the lighting device comprising the coating film of claim 6 on one or both of an outer surface and an inner surface of the lighting cover.

21. A lighting device including a lighting cover, the lighting device comprising the coating film of claim 7 on one or both of an outer surface and an inner surface of the lighting cover.
